(19) United States
(12) Patent Application Publication
(10) Pub. No.: US 2003/0138103 A1
(43) Pub. Date: Jul. 24, 2003

(54) Smart card

(76) Inventors: Gerd Dirscherl, Munchen (DE); Christian Schneckenburger, Hohenkirchen (DE); Thomas Rosteck, Otterfing (DE); Brigitte Wirtz, Holzkirchen (DE); Peter Laackmann, Munchen (DE)

Correspondence Address: LERNER AND GREENBERG, P.A., Post Office Box 2480, Hollywood, FL, 33022-2480, US

(21) Appl. No.: 10/371,133

(22) Filed: Feb. 21, 2003

Related U.S. Application Data
(63) Continuation of application No. PCT/DE01/02848, filed on Jul. 27, 2001.

(30) Foreign Application Priority Data
Aug. 21, 2000 (DE) 100 40 854.0

(51) Int. Cl. H04L 9/00

(52) U.S. Cl. 380/227; 713/172

(57) ABSTRACT

A smart card, in particular for pay-TV applications, has a microcontroller and a programmable-function hardware component that, together with the microcontroller, forms a unit. The function programming capability allows the crypto algorithm to be changed continuously, thus making it considerably more difficult, or impossible, to simulate the smart card. In one method, the smart card is used with a decoder for pay-TV transmitters. In this method, a control command is transmitted in the television signal and results in the reprogramming of the programmable-function hardware component.

### CROSS-REFERENCE TO RELATED APPLICATION:

This application is a continuation of copending International Application No. PCT/DE01/02848, filed Jul. 27, 2001, which designated the United States and was not published in English.

### BACKGROUND OF THE INVENTION:

### Field of the Invention:

The invention relates to a smart card, in particular for pay-TV applications, in which the decoding of a data signal without the smart card is prevented by scrambling.

The fundamental method of operation of pay-TV applications is for the television signal to be scrambled such that it cannot be displayed on a television. The television signal is descrambled in a decoder, which is known as a so-called set top box. In order to make it possible to use the decoder for a specific program, the user has to have a smart card, which is issued by the provider in return for payment.

In order to implement this technically, a so-called challenge value is transmitted in the blanking interval of the television signal, and is passed from the decoder to the smart card. A cryptographic algorithm is applied using a stored key to the challenge value in the smart card or in the microprocessor that is contained in it, and a response value is returned to the decoder, which can then descramble the television signal. The decoder is generally a standardized appliance, so that a number of pay-TV programs can be descrambled by the same decoder using different smart cards.

Since the cards for descrambling a television program are the same for all users, it has been found to be lucrative for attackers to use models to simulate the smart card functions, and to sell them. These models use conventional microprocessors and are often equipped with large portions of the original software of the pay-TV cards. The technical problem in preventing models being formed is based on the idea that all the cards in a system are functionally identical and can thus be modeled relatively easily.

In the past, attempts have been made to shorten the life of an illegal card simulator by regularly changing the cryptographic key. More modern simulators, however, allow the key to be changed via a keyboard or via a PC interface. The new keys are in turn disseminated via the Internet.

A further approach to prevent models from being formed is the integration of customer-specific modules (ASICs) as a second chip on the smart card module. These modules may, however, likewise be modeled in hardware on a simulator once they have been subjected to a reverse engineering process.

The problems relating to the use of smart cards for pay-TV applications or telephone cards are described in more detail in the journal titled “A la card”, Issue 26-27/97, pages 315 et seq., while the proposal is made to equip the smart cards with crypto coprocessors, in order to make modeling more difficult. Since their data throughput is high in comparison to external logic that is used for modeling their functions, reconstruction is feasible only likewise by using a crypto coprocessor. Although this makes reconstruction more difficult, the forbidden modeling process remains lucrative, however, owing to the large quantities.

German Patent DE 195 39 700 C1 discloses a security chip, which has a number of functionally different hardware components. One of the hardware components can in each case be selected by an appropriate command input. It is thus possible to make a selection from different crypto algorithms that are in each case implemented in a different hardware component. However, it is not possible to change the algorithms that are implemented during production. A smart card such as this can still be modeled by reverse engineering.

U.S. Pat. No. 6,055,314 discloses a method for viewing video programs using a smart card, as is specified in the prior art. In the configuration according to this document, it is likewise possible to forge the smart card and to obtain the key for descrambling the program illegally, for example from the Internet.

### SUMMARY OF THE INVENTION:

It is accordingly an object of the invention to provide a smart card that overcomes the above-mentioned disadvantages of the prior art devices of this general type, which makes illegal modeling even more difficult and which cannot be reconstructed by the procedures described above. A further aim of the invention is to specify a method for decoding a data signal, which allows the use of a smart card that is tamperproof against reconstruction.

The object is achieved by a smart card having a microcontroller and a programmable-function hardware component that is connected to and together with the microcontroller, forms a unit.

The smart card contains a programmable-function hardware component, so that only the instantaneous hardware state can be detected during analysis of the smart card. However, since this can be redefined with a programming method, a reconstruction of the smart card can operate only for the time until the hardware component is reprogrammed.

In accordance with an added feature of the invention, a programming apparatus is connected to and programs the programmable-function hardware component. The programmable-function hardware component is programmed by control commands supplied to the smart card.

With the foregoing and other objects in view there is provided, in accordance with the invention, a method for decoding a data signal. The method includes transmitting the data signal and a challenge value to a decoder, sending the challenge value to a smart card having a programmable-function hardware component, carrying out a crypto algorithm on the challenge value in the programmable-function hardware component, resulting in a response value, transmitting the response value to the decoder, and decoding the data signal using the response value. The programmable-function hardware component is modified by sending a control command to the smart card.

The control command for reprogramming the programmable-function hardware component is thus passed to the decoder with the data signal, in the same way as the challenge value that is normally used. Regular reprogramming at short time intervals is thus feasible, without any effort. For a pay-TV application, by way of example, reprogramming would be possible once an hour without any problems, with the user not being aware of it at all. Preferably, the control command is sent to the decoder in a blanking interval of a television signal.

It is advantageous for the crypto algorithm to be configured such that it can be carried out considerably more quickly in a hardware component than in software. This makes it impossible for the function of the smart card to be modeled by a programmable microcontroller.

Other features which are considered as characteristic for the invention are set forth in the appended claims.

Although the invention is illustrated and described herein as embodied in a smart card, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS:

FIG. 1 is a block diagram of a configuration having a smart card according to the invention, during normal operation; and

FIG. 2 is a block diagram of a configuration having a smart card according to the invention, during reprogramming.

### DESCRIPTION OF THE PREFERRED EMBODIMENTS:

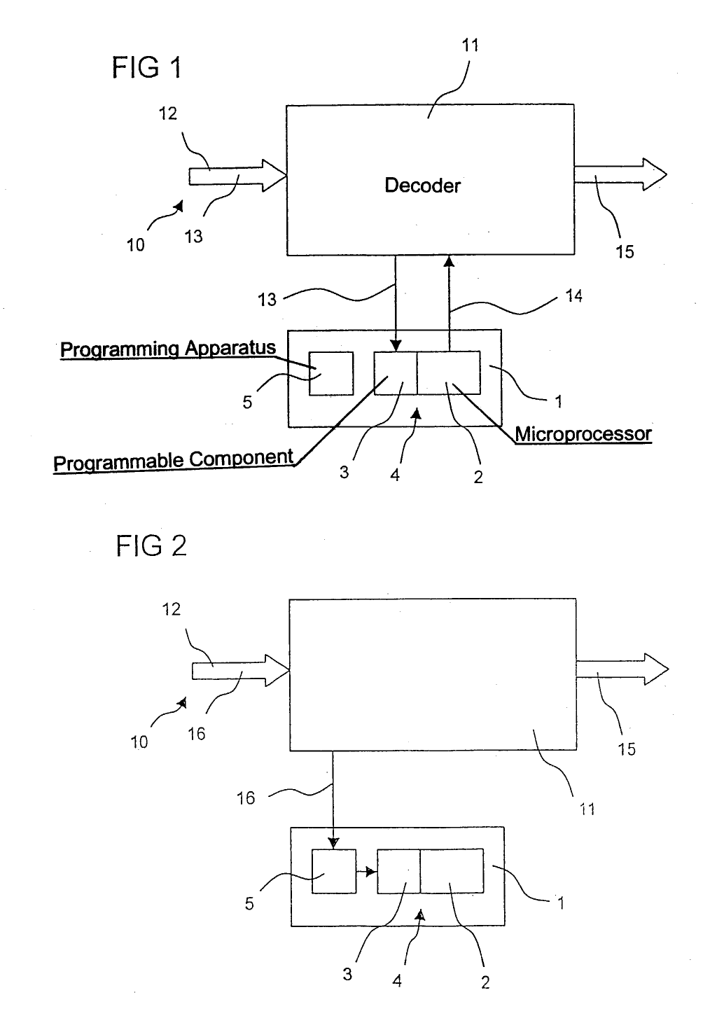

Referring now to the figures of the drawing in detail and first, particularly, to FIG. 1 thereof, there is shown the use of a smart card 1 according to the invention with a decoder 11. The smart card 1 has a microcontroller 2 and a programmable-function hardware component 3, for example a field programmable gate array (FPGA). Together with the programmable-function hardware component 3, the microcontroller 2 forms a unit 4. Furthermore, a programming apparatus 5 is provided for programming the programmable-function hardware component 3. During normal operation, a television signal 10 is transmitted to the decoder 11. The television signal 10 contains not only a data signal 12 for displaying the television pictures but also a challenge value 13 which, as described initially, is passed on to the smart card 1. The application of a crypto algorithm to the challenge value 13 by the microcontroller 2 and/or by the programmable-function hardware component 3 produces a response value 14, which is passed back to the decoder 11 and makes it possible for the decoder 11 to decode the data signal 12, and to pass it on as a video signal 15 to a television, on the basis of a key function of the response value 14 or of a definition of initial values.

FIG. 2 shows how the programmable-function hardware component 3 is reprogrammed. In this case, a programming command 16 is transmitted in the blanking interval with the data signal 12, so that the user is not aware of it. The decoder 11 passes the programming command 16 on to the smart card 1, where the programming apparatus 5 is then addressed, and carries out the reprogramming of the programmable-function hardware component 3. The broadcasting authority now has the capability to scramble the television signal in a different way and/or to change the challenge values such that decoding is possible only by using the reprogrammed function. If the reprogramming process is carried out frequently, for example once an hour, it is virtually impracticable for attackers to analyze the new algorithm on each occasion, and to program an FPGA appropriately.

Furthermore, the attacker cannot use any commercially available microcontroller for direct modeling of the pay-TV smart card but would need to start a complete reverse engineering process as well as fabrication of the unit 4 together with the microcontroller 2 and the programmable-function hardware component 3.

The use of the smart card 1 according to the invention and of the method according to the invention is, of course, not restricted to pay-TV applications, but can be used with any systems that make use of a challenge and response method.

We claim:

1. A smart card, comprising:
a microcontroller; and
a programmable-function hardware component connected to and together with said microcontroller, forms a unit.

2. The smart card according to claim 1, further comprising a programming apparatus connected to and programming said programmable-function hardware component.

3. The smart card according to claim 1, wherein said programmable-function hardware component is programmed by control commands supplied to the smart card.

4. The smart card according to claim 1, wherein a crypto algorithm is carried out by said programmable-function hardware component.

5. A method for decoding a data signal, which comprises the steps of:
transmitting the data signal and a challenge value to a decoder;
sending the challenge value to a smart card having a programmable-function hardware component;
carrying out a crypto algorithm on the challenge value in the programmable-function hardware component, resulting in a response value;
transmitting the response value to the decoder;
decoding the data signal using the response value; and
modifying the programmable-function hardware component by sending a control command to the smart card.

6. The method according to claim 5, which comprises receiving the control command in the decoder before the control command is passed on to the smart card.

7. The method according to claim 6, which comprises receiving the control command in the decoder in a blanking interval of a television signal.

8. The method according to claim 5, which comprises carrying out the crypto algorithm considerably more quickly in the programmable-function hardware component than in software.
